(19) United States
(12) Patent Application Publication
(10) Pub. No.: US 2026/0093105 A1
(43) Pub. Date: Apr. 2, 2026

(54) Method for the provision of transfer functions in the field of light field microscopy

(71) Applicant: Carl Zeiss Microscopy GmbH, Jena (DE)

(72) Inventors: Thomas EGLOFF, Weimar (DE); Stanislav KALININ, Weimar (DE); Volodymyr KUDRYAVTSEV, Jena (DE)

(73) Assignee: Carl Zeiss Microscopy GmbH, Jena (DE)

(21) Appl. No.: 19/343,444

(22) Filed: Sep. 29, 2025

(30) Foreign Application Priority Data
Sep. 30, 2024 (DE) 102024209567.2

(51) Int. Cl. G02B 21/36; G02B 21/00

(52) U.S. Cl. CPC G02B 21/367; G02B 21/0072

(57) ABSTRACT

The invention concerns a method for the provision of transfer functions in the field of light field microscopy, where a sample volume to be imaged is captured using a multitude of partial images (1 bis 12xy) from different angles of capture (Φ) and for which the respective point spread functions (PSF) for the partial images (1 through 12xy) intended for a 3D reconstruction of the sample volume are determined and assigned to the partial images (1 through 12xy).

A characteristic is that the partial images (1 through 12xy) are examined for existing symmetries of the optical-technical data they are based on and any found symmetries are captured and stored together with a computation formula. The computation formula makes it possible, starting from a point spread function (PSF) and/or a processed point spread function of a first partial image (1 through 12), to generate corresponding point spread functions (PSF) and/or processed point spread functions of other partial images (2x through 12xy) that are symmetric relative to the first partial image (1 through 12), where the point spread functions (PSF) and the processed point spread functions (PSF), respectively, of the other partial images (2x through 12xy) are only generated if needed and are only stored temporarily. A processed point spread function is obtained by executing at least one mathematical operation on the relevant point spread function. In addition, or alternatively, further symmetric subsets within the transmission function of at least one partial image (1 through 12xy) can be generated based on a first subset of the transmission function of a partial image (1 through 12xy), when and if needed.

The invention concerns a method pursuant to the umbrella term of the independent claim.

In the field of microscopy of dynamic systems, for example there is often the desire to capture three-dimensional sample volumes in a very short amount of time and while at the same time putting only minimal stress on the—oftentimes living—sample. In recent years, the so-called light field microscopy has proven to be very appropriate for this purpose. Principally, for this microscopy method, a detection radiation coming from the sample volume is split into a number of partial images. Based on the captured partial images, each of which contains different angle information of the sample volume, a 3D reconstruction of the sample volume can be computed, although the relevant sample was, in the simplest case, only captured once using a two-dimensional detector.

Each of the partial images inherently possesses, as an optical-technical property, a specific function that can be used to describe an optical transmission of a punctiform light source of the sample to the detector. Such mathematical relationships are for instance called a point spread function (PSF). Keeping such transmission functions on hand for a subsequent 3D reconstruction usually entails their transfer from a (main) data memory to a processing unit that actually performs the 3D reconstruction.

Due to the fact that such transmission functions describe complex three-dimensional relationships, they require a lot of memory to store. When transferring one or more transmission functions to the processing unit there are delays in the processing due to the significant amounts of data and the access times connected thereto. In addition, the memory (cache) of processing units is usually designed only for (intermediate) storage of comparatively small amounts of data.

The invention is based on the task of proposing a possibility to provide even voluminous transmission functions in an efficient way.

The task is fulfilled using a method pursuant to the main claim. Advantageous advancements are the subject of the dependent claims.

The method is used to provide transmission functions, especially in the field of light field microscopy. In it, detection radiation coming from a sample volume to be imaged is captured using a multitude of partial images from different angles of capture. All or a number of selected partial images are destined for a subsequent virtual 3D reconstruction of the sample volume. At least of these selected partial images is it that their respective point spread functions (hereinafter short PSF) are determined and stored with reference to the partial images. A determination of the PSF can for instance be done by way of measurement, simulation and/or computation.

According to the invention, the method is characterized by examining the partial images regarding present symmetries in the optical-technical (image) data they are based on. Symmetries primarily mean inherent properties of the partial images such as a respective PSF. A symmetry within the meaning of the description exists, if a transmission function of a first partial image can be transformed, by virtual mirroring it, into transmission functions that are valid for other captured partial images. Mirroring can for instance be done across a (mirror) axis which is orthogonal relative to the optical axis of a captured beam of the detection radiation and intersects with the optical axis. By way of example, further down in the description the x axis and the y axis, respectively, of a Cartesian coordinate system is used, whose z axis coincides with an optical axis specifically of a detection beam trajectory.

If symmetries are detected, these are captured and stored together with a computation formula. The computation formula allows it to generate corresponding PSF and/or processed PSF regarding the first partial image of symmetric partial images, based on a PSF and/or processed PSF (see below) of a first partial image that can also be understood as the original. Advantageously, the PSF and/or the processed PSFs of the other partial images can only be generated when necessary. For example, it might be necessary if a 3D reconstruction of the sample volume is done. Since the PSF or the processed PSF may at any time be translated into a desired symmetric PSF using the PSF of the first partial image and the corresponding computation formula, a PSF and/or processed PSF generated by using the computation formula advantageously only needs to be stored temporarily.

A processed PSF within the meaning of the description is obtained by executing at least one mathematical operation on the relevant PSF. Any result of the relevant mathematical operation is stored with reference to the corresponding partial image. In one embodiment of the methods the processed PSF can be an optical transfer function OTF. It is generated using a Fourier transformation of the PSF. In one embodiment of the method according to the invention a discrete Fourier transformation (DFT) is used.

Within the meaning of the invention, the term “transmission function” is understood to be a point spread function or processed point spread function, respectively, e.g. an OTF.

Symmetric partial images, to be more precise: symmetries in their properties can occur in the field of light field microscopy due to the fact that the partial images are generated by the impact of an optical element in the detection beam trajectory. If the optical element has symmetries in its design or if there are symmetries during the actual recording of the image, these symmetries can be used within the meaning of the invention. For instance, the micro lenses of a micro lens array used to generate the partial images may be arranged symmetrically relative to a virtual axis. If the micro lens array is positioned so that the virtual axis and the optical axis of the beam coincide during the recording process of the image, the micro lenses—and their respective generated partial images—, whose positions can be transformed into each other by mirroring, can be considered symmetric.

In addition, or alternatively, the computation formula can be used to generate more symmetric subsets within the image data of at least one partial image using a first subset of the transmission function of a partial image, if needed. As is explained below in more detail it is possible to generate subsets or sections, e.g. halves, of a PSF using a different section, e.g. based on the other half. This way it is also possible to use symmetries of the properties of the partial images, in particular symmetries of the occurring PSFs in themselves, in order to provide any and all necessary PSFs and/or processed PSFs (these are hereinafter also referred to as OTF) while at the same time reducing the amount of memory needed meaningfully. Subsets of an OTF can for example be captured as being symmetric relative to each other if these can be expressed as a complex conjugation with opposing imaginary part. A symmetric subset e.g. of a PSF can hence be described as PSF_{inverted} (x, y)=PSF(−x, −y). In a 2D Fourier space, this corresponds to the relation: OTF_{inverted}(kx, ky)=OTF*(kx, ky).

Therefore, the core of the invention is to take advantage of the fact that during the course of recording an image pursuant to the method of light field microscopy transmission functions are occurring that may be assigned to different spatial Positions but otherwise correspond to each other. In addition, there may be symmetries within the optical-technical data of a partial image that can advantageously be utilized within the method according to the invention.

The invention makes it possible to utilize the typical technical configurations of different data memory devices in an advantageous way. Data memory devices such as hard disks, RAM (random access memory) of a CPU (central processing unit) and VRAM (video random access memory) of a GPU (graphics processing unit) may offer a lot of memory, but they have a relatively slow data access speed and hence long data access times. Loading large amounts of data such as those of fully computed and stored transmission functions requires a correspondingly large amount of time.

In contrast, due to a higher data transfer speed, data in buffer memory (cache, on-chip memory, GPU shared memory) of processing units (processor) can be accessed up to 20 times faster (relative to the intern transfer rate L1/L2/L3). However, the amount of memory provided by such buffers is e.g. by a factor of 200 to 2000 lower than with the above data memory devices. E.g. a CPU or GPU may be used as processing units as well.

Now, despite that, the invention allows us to utilize the high data transfer rates of the buffer memory and to provide and use the complex transmission functions necessary for 3D reconstruction in an efficient manner.

In particular, if needed, e.g. during 3D reconstruction, only the PSF and/or the processed PSF of the first partial images may be stored in the buffer, and the necessary PSFs and/or the processed PSFs of the other partial images may be generated based on them by the processing unit itself (“on demand”). So, these need not be held available and loaded from a memory device characterized by lower data transfer rates.

For instance, the invention can be utilized advantageously, if a multitude of recorded images captured with the same PSF is to be processed. This situation is e.g. given if the same microscope with identical settings and the same optical elements, in particular in the detection beam, has been used for all of these recorded images. The PSF and/or the processed PSF of the first partial images can then be stored once in the processing unit's buffer memory and used as a basis e.g. for 3D reconstructions for the multitude of recorded images.

In order to reconstruct a sample volume, in each of the embodiments of the method according to the invention, data generated by way of experiment, i.e. the captured measurements and image data generated therefrom, can be compared to predicted data (“forward model”). For a specific partial image, i.e. an image of the sample from specific angles of capture (“viewing direction”), the forward model can be seen as the 2D projection P of a 3D model M of the sample convolved with the corresponding PSF.

In order to compute the forward model, transformation of the PSF using a discrete Fourier transformation DFT can be utilized:

$$P ( x , y ) = {\sum }_{z} 3 D D F {T}^{- 1} ( 3 D D F T ( P S F ( x , y , z ) ) \cdot 3 DDFT ( M ( x , y , z ) ) ) . \qquad ( 1 )$$

In cases where the PSF only changes slowly in z direction, equation (1) may be approximated as follows:

$$P ( x , y ) = {\sum }_{z} 2 D D F {T}^{- 1} ( 2 D D F T ( P S {F}_{z} ( x , y ) ) \cdot 2 DDFT ( {M}_{z} ( x , y ) ) ) , \qquad ( 2 )$$

where M_{z} und PSF_{z} are separate 2D layers of the object model M as well as the corresponding PSF. The operator “.” designates an element-wise product.

Equation (2) makes it possible to reduce the computational complexity and the access times (=RAM access count) and it supports the utilization of existing symmetries if the transfer functions.

In an advantageous embodiment of the method according to the invention, processed PFSs, in particular OTFs, of a captured light field are stored. OTFs like these may be defined as OTF_{LF}=2DDFT(PSF_{z}(x, y), resulting in an equation (3) in the form of

$$P ( x , y ) = {\sum }_{z} 2 D D F {T}^{- 1} ( {OTF}_{L F} \cdot 2 DDFT ( {M}_{z} ( x , y ) ) ) . \qquad ( 3 )$$

The proposed method for the provision of transmission functions according to the invention may advantageously be used in systems that are specifically designed for imaging using the concept of a light field. In particular, the method according to the invention can be used in context with a reconstruction method aimed at virtually reconstructing a sample volume captured using a multitude of partial images from different angles of capture.

The invention is explained in more detail below using figures and example embodiments.

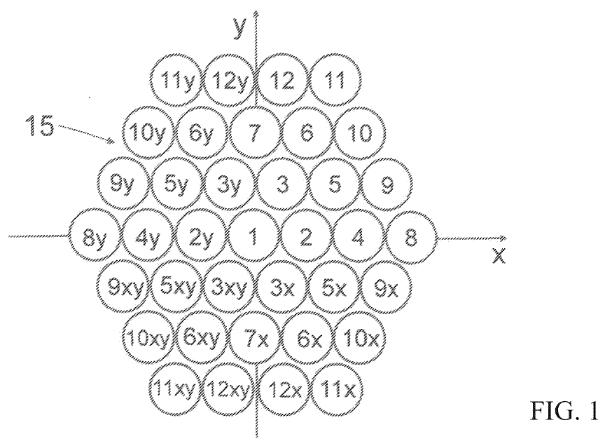

FIG. 1 shows a schematic depiction of a micro lens arrays as well as selected symmetries of the existing micro lenses;

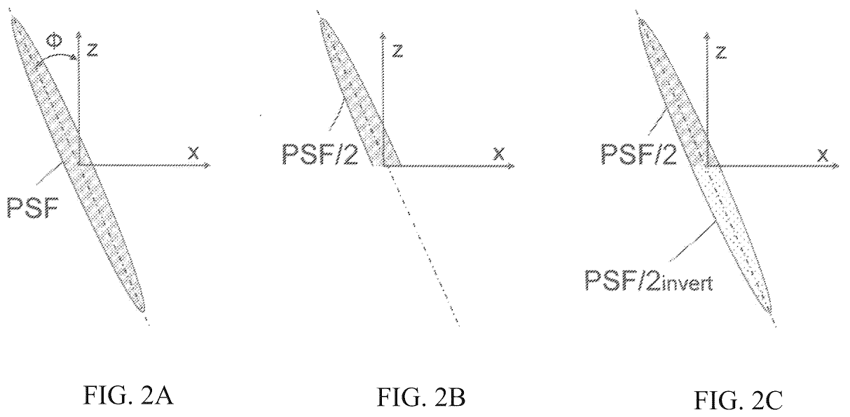

FIG. 2 a through c show a schematic depiction of a symmetry between subsets of a point spread function as well as their processing according to the invention;

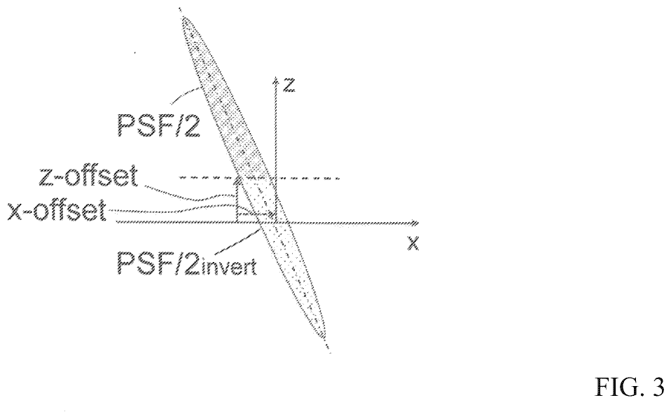

FIG. 3 shows a schematic depiction of an adjustment of the focal position based on the spatial positioning of a point spread function; and

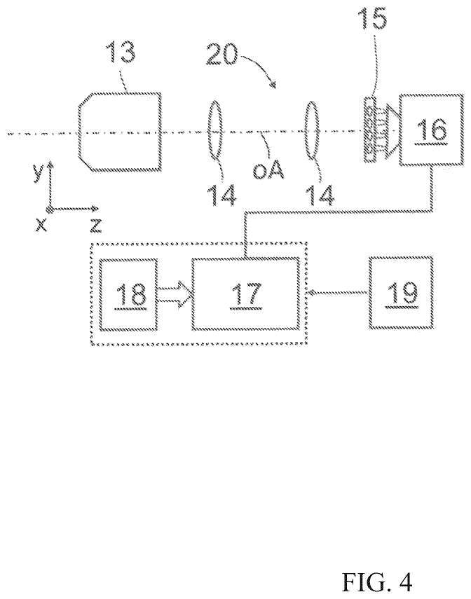

FIG. 4 shows a schematic depiction of an example embodiment of a light field microscope.

In FIG. 1, a first form of possible symmetries of the optical-technical image data of a detection radiation assumed by way of example. In a usual imaging system using a light field, e.g. a light field microscope 12 (see FIG. 4), a detection radiation coming from a sample volume to be imaged is directed to an optically active element, which acts to split up the detection radiation, and imaged on a downstream detector 16 (see FIG. 4) as a number of partial images. Each partial image is aiming at the sample volume under different angles of capture.

FIG. 1 shows a micro lens array 15 with a total of 37 micro lenses 1 through 12xy. Each of the micro lenses 1-12xy generates a partial image, which is why the micro lenses 1-12xy are set equal to the partial images 1 through 12xy associated therewith for the sake of a simpler explanation.

The micro lenses 1-12xy are essentially arranged concentrically around the central micro lens 1. In order to conduct the method according to the invention, the micro lens 1 is positioned in the optical axis of a detection beam. If micro lens array 15 is illuminated evenly, symmetries regarding the position of some of the micro lenses relative to each other can be found. In the example, the micro lenses 1 through 12 in the upper right quadrant are chosen as reference points (first partial images) by way of example. The actions of the micro lenses 1 through 12 generate the partial images 1 through 12.

As an example, FIG. 1 shows the x and y axis, which are orthogonal relative to the optical axis (z axis) as well as relative to each other. By mentally mirroring some of the micro lenses 2 through 12 across the x axis, across the y axis or subsequently across both the x and the y axis it is possible to find micro lenses identified as being symmetric. It can be assumed that the groups of symmetric micro lenses have equal point spread functions that merely have to be related to the relevant position of the concerned micro lens in micro lens array 15.

In the example, the micro lenses or partial images, respectively, that can be generated by mirroring across the x axis, are marked with the suffix “x”. The same is true for mirroring across the y axis or across both axis x and axis y. Due to its position at the origin of the coordinate system (=optical axis), micro lens 1 cannot be mirrored across the x or y axis.

The existing symmetries can e.g. be explained for micro lens 3. Micro lens 3 in the upper right-hand quadrant can be mirrored mentally across the x axis. At this location there is a micro lens that is herein referred to as 3x. Likewise, by mirroring micro lens 3 across the y-axis, a corresponding micro lens 3y can be found. If the latter is mirrored across the x axis, one arrives at micro lens 3xy. In the same way, micro lens 3x can also be mirrored across the y axis.

The so found micro lenses that are symmetrical to each other within this meaning, that is, their images, respectively, are captured and stored.

For micro lens 3, a corresponding point spread function PSF was determined and stored. By way of Fourier transformation of the point spread function PSF a processed PSF, in particular an optical transfer function OTF can be computed for micro lens 3. In order to provide the PSF and the OTF, respectively, within the meaning of the invention, also for the micro lenses 3x, 3y and 3xy in an efficient manner, the PSF and/or the OTF of micro lens 3 is supplemented using a respective computation formula for each of the micro lenses 3x, 3y and 3xy. For instance, in order to generate the PSF for micro lens 3xy, it is merely necessary to load the PSF of micro lens 3, which is stored anyway and consider, using the computation formula (e.g. by computing the complexly conjugated OTF), the relative position and the angle of capture of micro lens 3xy. This computation can for instance be done in a processing unit 17 and the so generated PSF can be stored in a buffer memory 18. The same is true for the generation and provision of a respective processed PSF, e.g. if an OTF. The other micro lenses or partial images, respectively, for which symmetric equivalents have been found, can be handled in this spirit.

In addition to the symmetry of the transmission functions encountered the fact that a transmission function, for instance a point spread function PSF, is mirror-symmetric along e.g. its longitudinal stretch, can be used. FIG. 2a shows, by way of example, a PSF in a view in a xz plane. The PSF is tilted relative to the x axis and the z axis by one angle each. The spatial position and orientation of the PSF describe the present angle of view (angle of capture @; shown lightly).

In order to economize on the amount of memory needed, e.g. only half of the PSF (PSF/2) may be stored and held available for any subsequent use (FIG. 2b). In order to be able to generate the missing second half PSF/2ᵢₙᵥₑₙₜ if needed, in addition to the PSF/2 data a formula is stored that can be used to quickly compute the second half PSF/2 invert from the data of the first half PSF/2 and generate a full PSF.

In order to compute the other half of the PSF using the above equations (1) and (2) for a 2D projection P, a mirrored PSF(see above) can be generated from the stored half PSF/2 of the original PSF. If an OTF/2 is to be completed, the OTF of the light field OTF_{LF} of equation (3) can be used. In this case the half of the OTF to be added can be computed using a complex conjugation of the OTF_{LF} in the directions of x, y and z.

In partial FIG. 2c the lower half of the PSF/2 added by applying the formula is shown as an example as PSF/2ᵢₙᵥₑₙₜ and illustrated by a different type if crosshatching.

In real world light field mapping systems a focal position of each of the micro lenses may be shifted along the direction of view and/or the angle of captures @. These shifts can be different from micro lens to micro lens, and they might additionally depend on the wavelength of the detection radiation.

In FIG. 3 such a case is shown by way of example. As already described above, the first subset of the PSF is loaded into the buffer memory 18 if processing unit 17 at first. Doing this in this case necessitates the transfer of the data of a subset of the PSF that extends a little over half of the PSF in z direction (for the sake of simplicity continued to be denoted as PSF/2). During the computation of the subset of the PSF/2 to be added the same will be shifted by an offset vector of the Form: [symbol] (Mikrolinse, Wellenlänge, z_{offset})=[x_{offset}, y_{offset}, z_{offset}] according to the offset of the focal position (focal offset) in each of the directions x, y, and z. The focal offset is determined by the storage of the actual focal position in the directions of x, y, and z in relation to a theoretical focal position.

The focal offset relative to the center of the PSF is transferred to the entire corresponding z plane of the PSF/2 and hence the PSF is shifted in the direction of z (z offset). In addition, the entire PSF is correspondingly shifted in the direction(s) of x and/or y. This can be done by a constant x-y offset which is set individually for each micro lens 1 through 12xy, or the determined x-y offset of the PSF is used.

In addition, because of the shifted focal position, a target area correspondingly changed in the directions of x, y, and in z (region of interest, ROI, not shown), for which the PSF is to be applied, is set.

As already explained with regard to FIG. 2, it is preferred to use the optical transfer function of the light fields OTF_{LF} pursuant to equation (3) is used for the computation. The subset of the PSF to be supplemented, or the processed PSF, respectively, is again computed using a complex conjugation with opposing imaginary part of the optical transfer function of the light fields OTF_{LF}. Any offset in the directions of x and/or y is generated based on the not shifted OTF_{LF} using a multiple 2D phase operator. The offset in the direction of z (z offset) is generated arithmetically by adding the corresponding z offset if the offset vector, followed by the computation of an area of interest in z direction (z-ROI) for both subsets of the OTF_{LF}. The computations are executed by the processing unit 17 as backwards projections, rather than computing complete PSFs and complete processed PSFs in corresponding intermediate steps.

The method according to the invention can be realized in a detection beam of e.g. a light field microscope 20 (FIG. 4). A detection radiation coming from a sample volume to be mapped is collected using an objective 13, led along the detection beam using a transmission optics 14 (shown much simplified) and directed to an optical element that acts to generate a number of partial images mapping the sample volume from different angles of view on a detector 16. In the sample embodiment, the optical element is realized as a micro lens array 15 with a number of micro lenses 1 through 12xy (see FIG. 1).

The measurements captured using detector 16 are handed over to a processing unit 17. It is configured to receive, from data memory 19, data of the transmission functions of a selection of the micro lenses 1 through 12xy as well as information about the existing symmetries of these in relation to the generated partial images as well as regarding existing symmetries in relation to the corresponding transmission functions themselves. The information on selected transmission functions as well as any computation formula are used to compute transmission functions using processing unit 17 when needed and store them in buffer memory 18 of processing unit 17, in particular in a manner so that they can be retrieved multiple times.

### REFERENCE TOKEN

1-12xy micro lens/partial image
13 objective
14 transmission optics
15 micro lens array
16 detector
17 processing unit
18 buffer memory
19 data memory (permanent, RAM)
20 microscope, light field microscope
OTF processed PSF, optical transfer function
PSF point spread function
Φ angle of capture

1. Method for the provision of transmission functions in the field of light field microscopy, where
a sample volume to be mapped is captured using a multitude of partial images (1 through 12xy) from different angles of capture (Φ);
the corresponding point spread functions (PSF) for the partial images (1 through 12xy) marked for 3D reconstruction of the sample volume are determined and are used assigned to the partial images (1 through 12xy);
characterized by
examining the partial images (1 through 12xy) for existing symmetries of the optical-technical data they are based on;
capturing found symmetries and storing them together with a computation formula, where the computation formula allows
to generate, starting from a point spread function (PSF) and/or a processed point spread function of a first partial image (1 through 12), corresponding point spread functions (PSF) and/or processed point spread functions of further partial images (2x through 12xy), that are symmetric in relation to the first partial image (1 through 12), where the point spread function (PSF) or processed point spread functions, respectively, of the further partial images (2x through 12xy) are only generated as needed as transmission functions and stored temporarily; where a processed point spread function is obtained by executing at least one mathematic operation on a respective point spread function (PSF),
and/or
to generate, as needed, symmetric further subsets within the transmission function of at least one partial image (1 through 12xy) based on a first subset of the transmission function of a partial image (1 through 12xy).

2. Method pursuant to claim 1, characterized by capturing those partial images (2 through 12xy) that can be translated into each other by mirroring across at least one mirror axis as being symmetric in relation to each other, where the at least one mirror axis is orthogonal relative to the optical axis of a captured beam of the detection radiation and intersects with the optical axis.

3. Method pursuant to one of the afore claims, characterized by the processed point spread function being an optical transfer function (OTF).

4. Method pursuant to one of the claims 1 through 3, characterized by determining subsets of a point spread function (PSF) as being symmetric relative to each other if they can be expressed in the form of PSF_{inverted} (x, y)=PSF(−x, −y).

5. Method pursuant to claim 3, characterized by determining subsets of an optical transfer function (OTF) as being symmetric relative to each other, if these can be expressed with a complex conjugation with opposite imaginary part.

6. Method pursuant to one of the afore claims, characterized by storing, during a 3D reconstruction, only point spread functions (PSF) or processed point spread functions, respectively, of the first partial images (1 through 12) in a buffer memory (18) of a processing unit (17) executing the 3D reconstruction, and generating the necessary processed point spread functions, in particular optical transfer functions (OTF) of the additional partial images (2x through 12xy) by processing unit (17), based on these.

7. Method pursuant to claim 6, characterized by storing the point spread function (PSF) or the processed point spread function, respectively, of the first partial images (1 through 12) only once in the buffer memory (18) of processing unit (17), if a multitude of recorded images is present that have been captured with the same point spread function (PSF).

8. Reconstruction method in the field of light field microscopy for the virtual reconstruction of a sample volume captured with a multitude of partial images (1 through 12xy) from different angles of capture (Φ), where a method pursuant to one of the afore claims is used for the provision of transmission functions.
